(19) United States
(12) Patent Application Publication
(10) Pub. No.: US 2012/0103287 A1
(43) Pub. Date: May 3, 2012

(54) Modifying an Internal Combustion Engine for Radical Ignition Combustion

(75) Inventors: William Paul McCowan, Queenstown, MD (US); John Spence Hayes Chapman, JR., White Hall, MD (US)

(73) Assignee: Total Energy Renewable Power Systems, LLC, Annapolis, MD (US)

(21) Appl. No.: 12/916,308

(22) Filed: Oct. 29, 2010

(51) Int. Cl. F02B 75/18; B23P 6/00

(52) U.S. Cl. 123/52.1; 29/888.011

(57) ABSTRACT

Methods and apparatus for modifying an internal combustion engine for radical ignition combustion to aid ignition and enhance combustion. In one embodiment, the present invention includes a method of modifying an internal combustion engine with at least one cylinder to control the production and flow of radical ignition species. An exemplary method comprises inserting a cylinder liner into the at least one cylinder, the cylinder liner comprising at least one radical production member for providing and storing radical ignition species. The cylinder liner has a lip section and at least one production member is disposed inside of the lip section. The cylinder liner also has at least one vent to fluidly connect each of the at least one production member to each of at least one lined cylinder in an engine block. The method further comprises attaching the cylinder liner and at least one production member to the engine block.

### BACKGROUND OF THE INVENTION

1. Field of the Invention

The field of the present invention relates to internal combustion engines.

2. Background Art

The internal combustion (IC) engine has long been a source for power, especially for transportation and stationary power. Improved control over the ignition and combustion efficiencies in an IC engine has been a long sought goal.

In conventional spark ignition (SI) engines and conventional compression ignition (CI) engines, the ignition process is driven by relatively high temperature chemical-kinetics mechanisms requiring relatively high levels of heat to start combustion. Also, for combustion initiated by SI and CI modes to be sustained, relatively higher concentrations of fuel relative to oxygen are typically required.

In more recent developments in the field of combustion technology and science, the importance of chemical activity leading up to the oxidation reaction of fuel substances as well as the physical environment needed for dependable spontaneous ignition, have led to research regarding the role of radical species of hydrocarbon fuels in the process of ignition and combustion of fuels in SI and CI internal combustion engines. In contrast to conventional SI and CI, radical ignition (RI) combustion can enable a reduction of the heat and/or compression ratio required for ignition and a reduction in the ratio of fuel and oxygen required for sustaining combustion.

Radical ignition combustion arises from the recognition that controlled seeding of a fuel charge before ignition in a SI or CI engine with highly active radical species of fuel generated in a cool flame process can produce dependable and predictable ignition and combustion. RI combustion involves the production of radical species during one combustion cycle and storing for discharge in a succeeding combustion cycle. During each combustion cycle, a portion of the fuel oxygen mixture is contained in a secondary chamber and undergoes a cool flame oxidation reaction to produce radical species that are discharged during a succeeding combustion cycle for seeding the next fuel-oxygen mixture charge released into the main combustion chamber. The process results in enhanced combustion by reducing the temperature or compression needed for ignition.

### BRIEF SUMMARY OF THE INVENTION

In embodiments, the present invention modifies a conventional internal combustion engine for radical species ignition. In one embodiment, the present invention includes a method of modifying a internal combustion engine with one or more cylinders to control the production and flow of radical ignition species for enhanced combustion. The method comprises inserting one or more cylinder liners into the one or more cylinders of the internal combustion engine. The cylinder liners comprise one or more radical production members for providing and storing radical ignition species. The cylinder liners have a lip section at one end of a body and one or more production members are disposed inside of the lip section of the cylinder liner and have one or more vents to fluidly connect each of the one or more production members to each of the one or more cylinders in an engine block. The method further comprises attaching the one or more cylinder liners and added one or more production members to the engine block. The cylinder liners are partially disposed between the engine block and a cylinder head of the internal combustion engine, such that each of the one or more production members fluidly connect to a corresponding main combustion chamber. The one or more lined cylinders define the corresponding main combustion chamber.

In an alternative embodiment, the present invention includes a method of modifying a internal combustion engine with one or more cylinders to control the production and flow of radical ignition species for enhanced combustion. The method comprises forming one or more annular channels in a top surface of an engine block around the circumference of one or more openings defining one or more cylinders in the engine block. The method further comprises inserting one or more cylinder liners into the one or more cylinders of the internal combustion engine. The cylinder liners comprise one or more radical production members for providing and storing radical ignition species. The one or more production members are disposed inside of the cylinder liners and have one or more openings to fluidly connect each of the one or more production members to each of the one or more cylinders. The method also comprises assembling an engine block, the one or more radical production members, and a cylinder head.

Another embodiment of the present invention relates to a modified internal combustion engine, comprising a cylinder head and an engine block. The engine block contains a plurality of cylinders and a plurality of pistons. The modified internal combustion engine comprises one or more cylinder liners, wherein the cylinder liners include a lip section and a body section. A plurality of main combustion chambers are defined by the lined cylinders, the pistons, and the cylinder head. The cylinder liners comprise a plurality of production members, wherein the production members are disposed within the lip section of the cylinder liner and include one or more vents to fluidly connect the production members with the main combustion chambers. The cylinder liners are partially disposed between the engine block and the cylinder head and attached to the engine block via a friction fit.

In another embodiment, the present invention includes an apparatus. The apparatus comprises a cylinder liner and a plurality of production members. The cylinder liner includes a lip section and a body section. The body section is shaped and sized to friction fit within one of a plurality of cylinders in an engine block. The production members are disposed within the lip section of the cylinder liner and include one or more vents to fluidly connect the production members with one of a plurality of main combustion chambers defined by the plurality of lined cylinders.

In additional embodiments, the present invention modifies a conventional internal combustion engine for radical species ignition. In one embodiment, the present invention includes a method of modifying a internal combustion engine with one or more cylinders to control the production and flow of radical ignition species for enhanced combustion. The method comprises adding to a gasket a plurality of reservoirs for providing and storing radical ignition species. The gasket has one or more openings corresponding to the one or more cylinders in an engine block and the plurality of reservoirs are disposed inside of the gasket. The gasket has one or more vents to fluidly connect each of the plurality of reservoirs to one or more cylinders in the engine block. The method further comprises attaching the gasket and added plurality of reservoirs to the engine block. The gasket is then disposed between the engine block and a cylinder head of the internal combustion engine, such that the one or more openings correspond to the one or more cylinders in an engine block, and each of the plurality of reservoirs fluidly connect to a corresponding main combustion chamber. The one or more cylinders define the corresponding main combustion chamber.

Another embodiment of the present invention relates to a modified internal combustion engine. The modified internal combustion engine comprises a cylinder head, a gasket, a plurality of reservoirs, and an engine block containing a plurality of cylinders and a plurality of pistons. The modified internal combustion engine comprises a plurality of main combustion chambers defined by the cylinders, the pistons, and the cylinder head. The gasket includes a plurality of openings corresponding to the plurality of cylinders in the engine block. The plurality of reservoirs are disposed within the gasket and include one or more vents to fluidly connect the reservoirs with the main combustion chambers. The gasket is disposed between the engine block and the cylinder head and attached to the engine block via a plurality of head bolts.

In another embodiment, the present invention includes an apparatus. The apparatus comprises a gasket and a plurality of reservoirs. The gasket includes a plurality of openings corresponding to a plurality of cylinders in an engine block. The plurality of reservoirs are disposed within the gasket and include one or more vents to fluidly connect the plurality of reservoirs with a plurality of main combustion chambers defined by the cylinders.

Further embodiments, features, and advantages of the present invention, as well as the structure and operation of the various embodiments of the present invention, are described in detail below with reference to the accompanying drawings.

It is to be understood that both the foregoing general description and the following detailed description are exemplary and explanatory only, and are not restrictive of the invention as claimed.

### BRIEF DESCRIPTION OF THE DRAWINGS/FIGURES

The accompanying figures, which are incorporated herein and form part of the specification, illustrate a cylinder assembly for a modified IC engine. Together with the description, the figures further serve to explain the principles of the a modified IC engine described herein and thereby enable a person skilled in the pertinent art to make and use the modified IC engine.

FIG. 1 is a cross sectional view of an exemplary cylinder assembly made according to an embodiment of the present invention.

FIG. 2 is a plan view of an exemplary multi-cylinder spacer plate made according to an embodiment of the present invention.

FIG. 3 is a perspective view of an exemplary radical production member made according to an embodiment of the present invention.

FIG. 4 is a cross sectional view of an exemplary cylinder assembly made according to another embodiment of the present invention.

FIG. 5 is a cross sectional view of an exemplary cylinder assembly made according to another embodiment of the present invention.

FIG. 6A is a cross sectional view of an exemplary cylinder liner made according to another embodiment of the present invention.

FIG. 6B is a top view of the exemplary cylinder liner in FIG. 6A.

FIG. 7 is a plan view of an exemplary multi-cylinder gasket made according to an embodiment of the present invention.

### DETAILED DESCRIPTION OF THE INVENTION

Reference will now be made in detail to embodiments of the present invention with reference to the accompanying figures, in which like reference numerals indicate like elements.

Embodiments of the present invention relate to methods and apparatus for modifying a conventional internal combustion engine for radical species ignition for enhanced ignition and combustion.

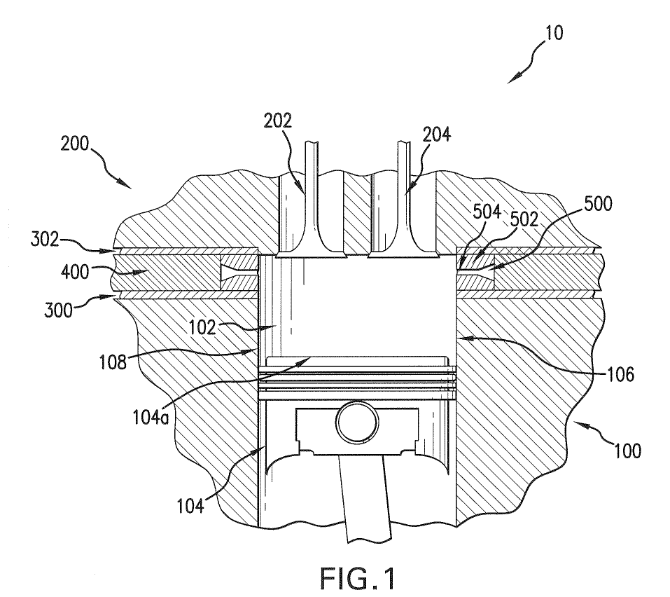

FIG. 1 is a diagram showing a cross-sectional view of an exemplary cylinder assembly 10. Cylinder assembly 10 can be part of a modified internal combustion engine (not shown) made according to an embodiment of the present invention. In one embodiment, cylinder assembly 10 can be incorporated into a single cylinder modified internal combustion engine. In other embodiments, a plurality of exemplary cylinder assembly 10 can be incorporated into a multi-cylinder modified internal combustion engine. For example, a plurality of cylinder assembly 10 can be incorporated into a 2-cylinder IC engine, a 4-cylinder IC engine, a 6-cylinder IC engine, an 8-cylinder IC engine or any other known multi-cylinder configuration of an IC engine known to one of skill in the art to modify an IC engine according to an embodiment of the present invention.

Cylinder assembly 10 includes an engine or cylinder block 100, cylinder head 200, first and second head gaskets 300 and 302, cylinder spacer plate 400, and radical production members 500. Engine block 100 includes main combustion chamber 102, piston 104, and cylinder wall 106. Cylinder head 200 includes intake valve 202 and outtake valve 204. Radical production members 500 include grooves 502 and opening 504. Engine block 100, first head gasket 300, cylinder spacer plate 400, second head gasket 302, and cylinder head 200 are attached and secured via head bolts (not shown) to form cylinder assembly 10 of an IC engine modified according to an embodiment of the present invention. Cylinder spacer plate 400, disposed between engine block 100 and cylinder head 200, creates a volume of space for inserting radical production members 500 into cylinder assembly 10. Radical production members 500 are for producing and storing radical ignition species for conversion of a conventional IC engine to a radical ignition engine for enhanced combustion.

As illustrated in FIGS. 1-3, a conventional IC engine is easily adapted for radical ignition by modifying cylinder assembly 10 to include radical production members 500 for producing and storing radical ignition species. Because the present invention does not require modification of the piston(s) 104 or the cylinder head 200 of the IC engine, any conventional off-the-shelf IC engine, such as a diesel engine, gasoline engine, 4-stroke or 2-stroke multi-cylinder IC engine, and the like may be modified according to the present invention for radical ignition. Furthermore, because engine 10 is modified by the addition of radical production members 500 adjacent to main combustion chambers 102 in cylinder block or engine block 100, engine 10 can be easily adapted for use with multiple fuel types. For example, a diesel IC engine can be readily adapted for use with alcohol based fuels with minimal further modification of engine 10.

In one embodiment of the present invention, a method of modifying an IC engine comprises the steps of adding a cylinder spacer plate with a plurality of openings to the IC engine, wherein the openings correspond to a plurality of cylinders in an engine block of the multi-cylinder internal combustion engine; adding a plurality of radical production members for providing and storing radical ignition species, wherein the production members are disposed inside of the openings in the cylinder spacer plate and have at least one opening or vent to fluidly connect each of the production members to each of the plurality of cylinders; and attaching the cylinder spacer plate to the engine block, wherein the spacer plate is disposed so as to be between the engine block and a cylinder head of the internal combustion engine.

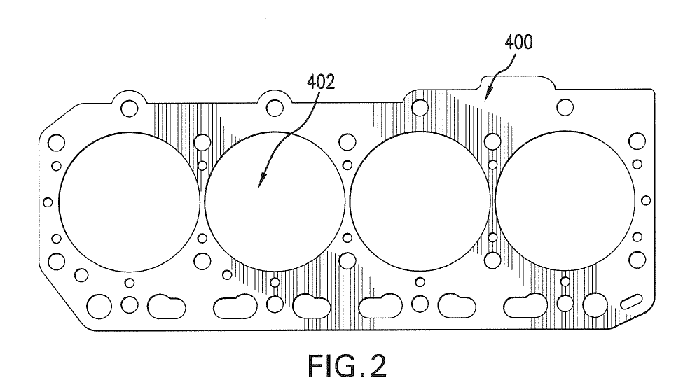

The step of adding may involve creating cylinder spacer plate 400 to be a mirror image in shape of a head gasket 300 such that the openings 402 of spacer plate correspond in location to the main combustion chambers 102 in engine block 100, as shown in FIG. 2. Main combustion chambers 102 are defined by a top surface 104a of piston 104, the inner wall 106a of cylinder 106 and cylinder head 200. Openings 402 should be of a sufficient diameter for securely housing radical production members 500. Also, spacer plate 400 should be of a sufficient thickness to create a volume of space, between engine block 100 and cylinder head 200, in which radical production members 500 may be disposed so a top surface 500a and a bottom surface 500b of production members 500 are flush or substantially even with a top surface and a bottom surface of spacer plate 400. The thickness of spacer plate 400 will depend on the size of radical production members 500 which is dependent on the fuel type used for engine 10. For example, the thickness of production members 500, and likewise the thickness of spacer plate 400, should be sufficient to create a volume of void space for storing radical species ranging from one twentieth ( 1/20) to one quarter (¼) of the volume of combustion chamber 102 when piston 104 is at top-dead-center.

Also, by mirroring the shape of head gasket 300, a set of head bolts for securing head gasket 300 to engine block 100 can be utilized for attaching spacer plate 400 as well to the engine block without having to alter the engine block, head gasket, and cylinder head for securing spacer plate 400.

Cylinder spacer plate 400 can be made through any conventional metal manufacturing process. For example, spacer plate 400 may be manufactured through a Computer Numeric Control (CNC) machining process. In other embodiments, the spacer plate may be created via conventional milling processes or any other suitable machining process for precision machining of metal materials known to one of ordinary skill in the art.

Spacer plate 400 can be manufactured from aluminum or steel. Other examples of materials that may be used for creating spacer plate 400 include iron, titanium, ceramics, or any other suitable material that is capable of maintaining the proper temperature range for the production and storage of radical species known to one of ordinary skill in the art.

Spacer plate 400 may be attached to engine block 100 via conventional head bolts. Because spacer plate 400 corresponds in shape to head gasket 300, it is not necessary to alter the engine block for attaching spacer plate. Spacer plate 400 should be disposed above engine block 100 and above a first head gasket 300 and secured via head bolts. Generally, the existing head bolts for engine 10 can be used, however, in some embodiments, it may be necessary to replace the existing head bolts with a second set of head bolts longer in length so as to accommodate the thickness of space plate 400.

The method comprises adding a plurality of radical production members 500 for producing and storing radical ignition species. Production members 500 serve as origination sites for the generation of a plurality of radical ignition species during a combustion cycle of the engine and allow for storage of radical species for release during succeeding combustion cycles.

Radical production members 500 can be made via any suitable metal or ceramic manufacturing process. For example, in one embodiment, production members 500 may be created through a Computer Numeric Control (CNC) machining process. In other embodiments, the production members may be created via conventional milling or turning processes or any other suitable machining process for precision machining of metal materials known to one of ordinary skill in the art. In some embodiments, the production members can be created from ceramic materials via ceramic manufacturing processes such as, for example, casting, extrusion, or any other suitable method known to one of skill in the art.

Production members 500 can be made from any suitable metal or ceramic material that can tolerate the heat of combustion for the selected fuel type to be used in the modified IC engine. In some embodiments, the material used for creating production members 500 should be suitable for tolerating heat transfer rates ranging from 5 BTU/lbs-hr to 100 BTU/lbs-hr depending on the selected fuel source. For example, in one embodiment for modifying a diesel or other heavy fuel engine, production members 500 may be made from steel or any other suitable material know to one of ordinary skill in the art having a heat transfer rate ranging from about 5 BTU/lbs-hr to 30 BTU/lbs-hr. Alternatively, production members 500 may be made from iron, nodular iron or any other suitable material know to one of ordinary skill in the art having a heat transfer rate ranging from about 15 BTU/lbs-hr to 25 BTU/lbs-hr for use with ethanol, methanol, or other alcohol based fuel sources.

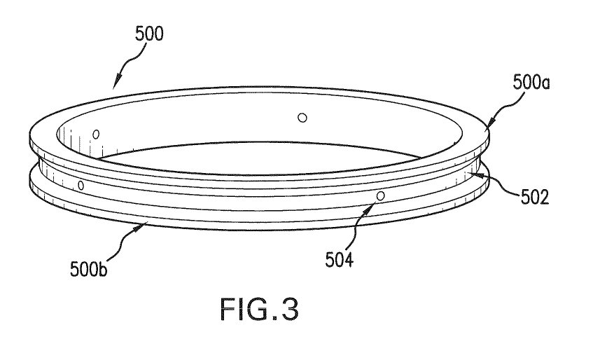

As shown in FIG. 3, radical production members 500 are substantially circular rings that are similar in diameter to the diameter of the main combustion chambers 102 in engine block 100. Production members 500 may have grooves or channels 502 formed in the outer circumferential surface of production members 500 to create a volume of space for producing and storing radical ignition species. In one embodiment, groove 502 formed in a production member 500 can be a single continuous channel spanning the complete outer circumferential surface. In other embodiments, groove 502 can be segmented in the outer circumferential surface of production member 500.

Also, production members 500 have a plurality of openings or vents 504 so as to fluidly connect production members 500 with main combustion chambers 102 in engine block 100 to allow the flow of a plurality of radical ignition species into main combustion chambers 102. The openings 504 are of sufficient size to allow sufficient mass transfer of radical species for radical ignition. However, the size of the openings should be sufficiently small to prevent the flame front from entering the openings and consume the radical species in the production members. The size of the openings will depend on the type of fuel being used in the IC engine but will typically be in the range of 1 to 1.5 mm in diameter.

Production members 500 are disposed in openings 402 within spacer plate 400 so at to be fluidly connected with combustion chambers 102. In one example, production members 500 are removeably attached to spacer plate 400 and held securely in openings 402 due to tension caused by the small size difference between the diameter of the openings 402 and outer diameter of members 500. Because production members 500 are removably secured to openings 402, in one embodiment, members 500 can be removed and replaced with a second set of production made from a different material for use with a different fuel type. For example, a first set of members made from steel for use with diesel fuel can be easily replaced with a second set of members made from iron for use with an alcohol based fuel type.

Once spacer plate 400 and production members 500 are manufactured, they may be attached to engine block 100 to modify a conventional IC engine to a radical ignition combustion engine. To assemble the modified IC engine in one embodiment, a first head gasket 300 is disposed on top of engine block 100, then spacer plate 400 is disposed on top of first head gasket 300 and production members 500 are disposed within openings 402 of the spacer plate. Then a second head gasket 302 is disposed above spacer plate 400 and production members 500 so that spacer plate 400 and members 500 are sandwiched between first and second head gasket 300 and 302. First and second head gaskets 300 and 302 are sandwiched between engine block 100 and cylinder head 200 to create a cylinder assembly for the modified IC engine. By using head gaskets 300 and 302 above and below spacer plate 400 and production members 500, a fluid seal is created at the joints between spacer plate 400 and production members 500 and it is unnecessary to permanently seal the joints. Creating a fluid seal prevents radical species from escaping production members and preserves radical species for use during the combustion cycle in the main combustion chambers.

In other embodiments, a fuel control system may be added to the modified IC engine to control the flow of the fuel and radical species to main combustion chamber. Conventional, off the shelf, control devices may be modified to control the fuel flow of a modified IC engine for radical combustion. For example, computer management systems, which include fuel injector controls, carburetor controls, ignitions controls, and other standard control systems may be modified for optimization of the radical combustion in the modified IC engine.

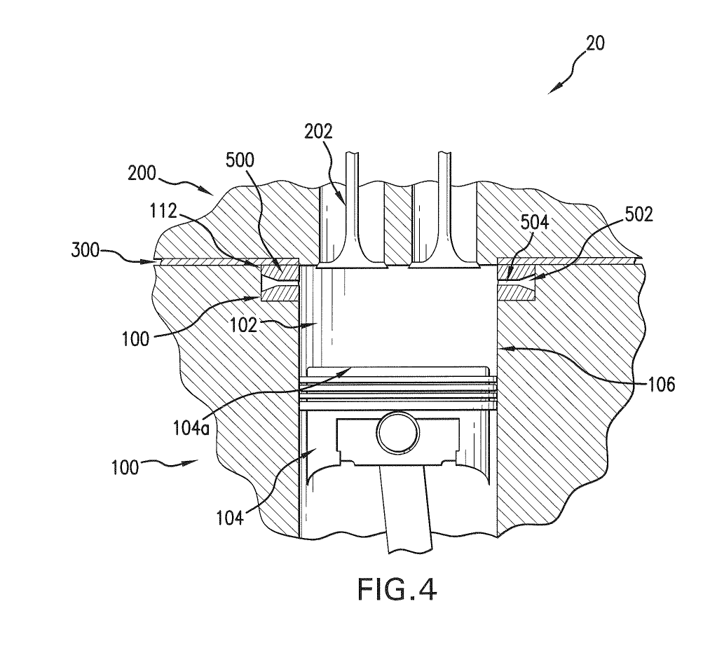

In another embodiment, as shown in FIG. 4, a spacer plate is not necessary to create a volume of space for housing production members 500. Rather, a volume of space for containing production members is created directly in engine block 100. Circular channels 110 are formed in engine block 100 around the perimeter of combustion chambers 102. Channels 110 are of sufficient diameter and depth to accommodate the largest diameter of and thickness of production members 500 such that when the production members are disposed within channels 110 the upper surfaces of the production members are flush or even with the upper surface of engine block 100. Production members 500 are be disposed in channels 110 so as to be fluidly connected to main combustion chambers 102 to prevent radical species from escaping production members 500. Because the production members are disposed within engine block 100, only a first head gasket is needed to create a fluid seal at the joint 112 between engine block 100 and production members 500.

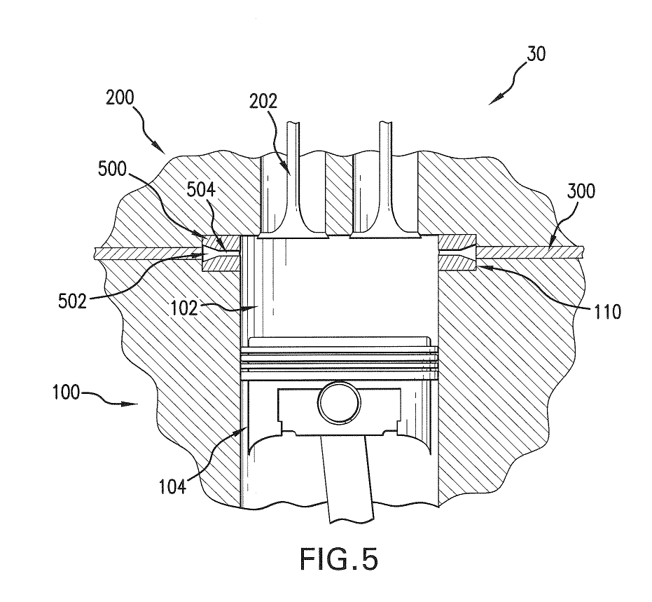

In another embodiment, as shown in FIG. 5, channels 110 for housing production members 500 may be created in both engine block 100 and cylinder head 200 so as to create a sufficient void space for accommodating production members 500. Circular channels 110 are formed in engine block 100 around the perimeter of combustion chambers 102 and in cylinder head 200 so as to correspond to the channels in engine block 100. Channels 110 in engine block 100 are of sufficient diameter and depth to accommodate the largest diameter and a portion of the thickness of production members so that, when members are disposed within channels 110 of engine block 100 and of cylinder head 200, engine block 100 and cylinder head 200 can be secured together without a gap or void space between the engine block and cylinder head. Production members 500 are be disposed in channels 110 so as to be fluidly connected to main combustion chambers 102.

To assemble a modified IC engine in accordance with this embodiment of the present invention, production members 500 are disposed within channels 110 in the engine block, a head gasket 300 is disposed on above a top surface of engine block 100, and cylinder head 200 is disposed above a head gasket 300 so that the channels in cylinder head align with production members 500 and house the remaining thickness of production members which is extended above the top surface of engine block 100.

Engine block 100 includes a plurality of pistons 104, slidably disposed in cylinders 106 and main combustion chambers 102 are defined by an upper surface of piston 104a, the inner wall 108 of cylinders 106 and cylinder head 200. Cylinder head 200 preferably includes a plurality of intake valves 202 and exhaust values 204 that are in communication with main combustion chamber 102. Additionally, cylinder head 200 may include an intake manifold, outtake manifold, and spark plugs, not shown.

In operation of a modified engine made in accordance with an embodiment of the present invention, radical species produced during a combustion cycle of the modified IC engine to assist ignition and enhance combustion. At the start of a combustion cycle, the radical species in production members 500 are generally in a state of equilibrium. As the combustion cycle processes, naturally occurring pressure differences between production members 500 and main combustion chambers 102 cause some of the radical species in each production chamber to transfer to main chambers 102 through openings 502 in production members 500. The radical species “seed” the fuel charge in main chambers 102 for radical ignition to enhance combustion. The combustion of the modified IC engine may be enhanced by optimizing the radical combustion. To optimize the radical combustion of the modified IC engine, the compression ratio for the modified IC engine may be altered. Optimization of the radical combustion in the modified IC engine can also improve the fuel economy and/or emissions of the modified IC engine in comparison to a corresponding un-altered IC engine.

### Cylinder Liner

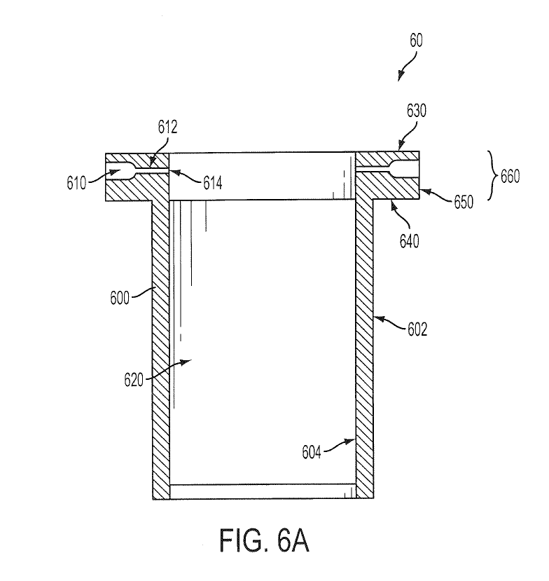

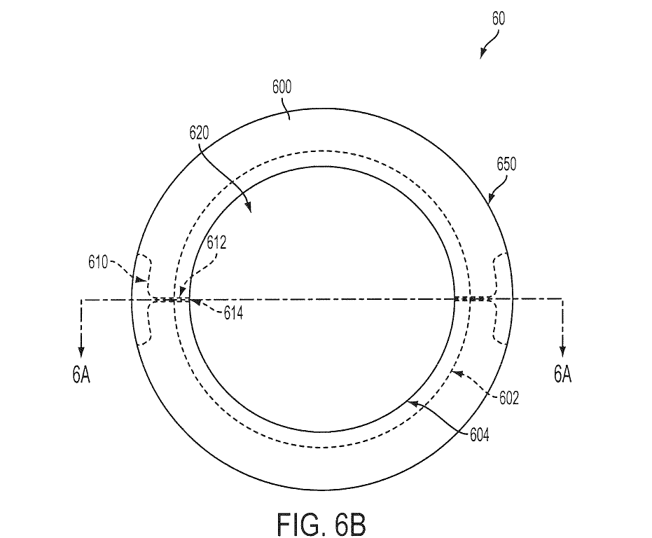

In another embodiment, FIGS. 6A and 6B show an exemplary cylinder sleeve or liner 60 that may be used alternatively for production and storage of radical ignition species for conversion of a conventional IC engine to a radical ignition engine for enhanced combustion. A cylinder sleeve or liner is a removable cylinder bore that fits into the existing cylinder without requiring machining of the existing cylinder. Cylinder liner 60 comprises a body 600, with inner 604 and outer 602 walls, a lip section 660, with outer 650, upper 630, and lower 640 surfaces, and a central bore 620 where the piston (not shown) is free to travel. The lip section 660 comprises a radical production member 610. The thickness of production member 610, and likewise the thickness of lip section 660, should be sufficient to create a volume of void space for storing radical species ranging from one twentieth ( 1/20) to one quarter (¼) of the volume of combustion chamber 620 when piston (not shown) is at top-dead-center. There may be a plurality of radical production members 610, lowering the thickness and in turn the volume needed for each of the plurality of radical production members 610. Radical production members 610 include a connecting vent 612 and an opening 614. The connecting vent 612 and the opening 614 fluidly connect production members 610 with main combustion chambers 620 in engine block 100 to allow the flow of a plurality of radical ignition species into main combustion chambers 620. The openings 614 are of sufficient size to allow sufficient mass transfer of radical species for radical ignition. However, the size of the openings should be sufficiently small to prevent the flame front from entering the openings and consume the radical species in the production members. The size of the openings will depend on the type of fuel being used in the IC engine but will typically be in the range of 1 to 1.5 mm in diameter. Likewise, the length of the connecting vent 612 is sufficiently long to prevent the flame front from entering the production member 610 but still short enough to allow for sufficient mass transfer of radical species for radical ignition. In one example, this length is approximately 10 mm.

The cylinder liner 60 can be placed into the main combustion chamber 102 of an engine block 100 (see e.g., FIG. 1) and function similarly to radical production ring 500 shown in FIG. 3. Cylinder liner 60 can be integrated into the engine block 100 identically to the manner in which radical production ring 500 is integrated in FIGS. 1, 4, and 5, That is, the cylinder sleeve 60 can be sized and placed flush with a spacer plate 400 as in FIG. 1, or the engine block 100 can be machined to accept the lip section 660 as in FIG. 4, or both the engine block 100 and the cylinder head 200 can be machined to accept the lip section 660 as in FIG. 5. In each of these examples, the outer wall 602 of the cylinder liner 60 body 600 is friction fit against the cylinder wall 102. This prevents slipping of the sleeve 60 during piston 104 travel. Likewise, the outer 650, upper 630, and lower 640 surfaces of lip section 660 would be sized and placed so as to create a fluid seal at the joints between the surrounding components (different depending on which embodiment (e.g., FIG. 1, 4, or 5) the cylinder liner 60 is used in) and the lip section 660. It is unnecessary to permanently seal the joints. Creating a fluid seal prevents radical species from escaping production members and preserves radical species for use during the combustion cycle in the main combustion chambers. The inner wall 604 of the cylinder liner 60 body 600 now becomes the surface that the piston 104 seals and slides against.

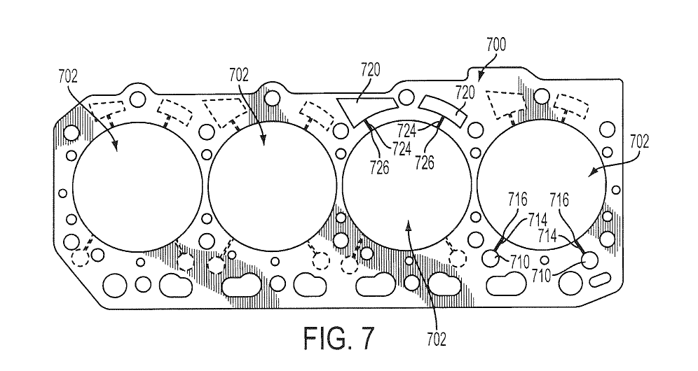

In still another embodiment, FIG. 7 shows a plan view of a gasket 700 with openings 702 corresponding in location to the main combustion chambers 102 in engine block 100. Gasket 700 may be used in place of gasket 300 shown in FIGS. 1, 4, and 5. FIG. 7 also shows two different kinds of mini chambers or reservoirs 710/Atty. 720 for production and storage of radical ignition species for conversion of a conventional IC engine to a radical ignition engine for enhanced combustion. Reservoirs 710 are circular in shape and sized to supply and store a sufficient amount of radical ignition species to effectively enhance combustion of a conventional IC engine. Reservoirs 720 are contoured in such a way to match the available area in the gasket and sized to supply and store a sufficient amount of radical ignition species to effectively enhance combustion of a conventional IC engine. The reservoirs 710 are connected to the gasket openings 702, and thus to the combustion chamber 102 via connecting vents 714 and opening 716. The reservoirs 720 are connected to the combustion chamber openings 702, and thus to the combustion chamber 102 via connecting vents 724 and opening 726. The connecting vent 714/724 and the opening 716/726 fluidly connect reservoirs 710/720 with main combustion chambers 102 in engine block 100 to allow the flow of a plurality of radical ignition species into main combustion chambers 102. The openings 716/726 are of sufficient size to allow sufficient mass transfer of radical species for radical ignition. However, the size of the openings should be sufficiently small to prevent the flame front from entering the openings and consume the radical species in the production members. The size of the openings will depend on the type of fuel being used in the IC engine but, in one example, will typically be in the range of 1 to 1.5 mm in diameter. Likewise, the length of the connecting vent 714/724 is sufficiently long to prevent the flame front from entering the reservoirs 710/720 but still short enough to allow for sufficient mass transfer of radical species for radical ignition. In one example, this length is approximately 10 mm. As shown by phantom lines connected to each of the four exemplary gasket openings 702, as many or as few of one or both kinds of reservoirs 710/720 may be connected to the each cylinder. The quantity and choice of reservoirs 710/720 needed depends on the shape and size of the reservoirs available and simply needs to encompass enough volume to produce and store a sufficient amount of radical ignition species to effectively enhance combustion of a conventional IC engine. For example, the thickness and size of a plurality of reservoirs 710/720, should be sufficient to create a volume of void space for storing radical species ranging from one twentieth ( 1/20) to one quarter (¼) of the volume of combustion chamber 102 when piston 104 is at top-dead-center. In one example, the gasket 700 is at least 3 mm thick. Use of the reservoir gasket 700 may be used in connection with the production member 500 or cylinder liner 60, but may be used in place of these components to provide sufficient production and storage volume for the radical ignition species.

While various embodiments of the present invention have been described above, it should be understood that they have been presented by way of example only, and not limitation. It will be apparent to persons skilled in the relevant art that various changes in form and detail can be made therein without departing from the spirit and scope of the present invention. Thus, the breadth and scope of the present invention should not be limited by any of the above-described exemplary embodiments, but should be defined only in accordance with the following claims and their equivalents. All patents and publications discussed herein are incorporated in their entirety by reference thereto.

1. A method of modifying an internal combustion engine with at least one cylinder to control the production and flow of radical ignition species for enhanced combustion, comprising:
inserting a cylinder liner into the at least one cylinder of the internal combustion engine, the cylinder liner comprising at least one radical production member for providing and storing radical ignition species, wherein the cylinder liner has a lip section at one end of a body and the at least one production member is disposed inside of the lip section of the cylinder liner and has at least one vent to fluidly connect each of the at least one production member to each of at least one cylinder in an engine block; and
attaching the cylinder liner and added at least one production member to the engine block, wherein the cylinder liner is partially disposed between the engine block and a cylinder head of the internal combustion engine, such that each of the at least one production member fluidly connects to a corresponding main combustion chamber, wherein the at least one lined cylinder defines the corresponding main combustion chamber.

2. The method of claim 1, wherein the attaching further comprises:
disposing the lip section of the cylinder liner between a first head gasket and a second head gasket and within an opening of a cylinder spacer plate,
wherein the first and second head gaskets are disposed between the engine block and the cylinder head of the internal combustion engine, and
wherein an assembly of the engine block, the first head gasket, the spacer plate, the second head gasket, and the cylinder head is secured via a set of head bolts.

3. The method of claim 1, wherein the at least one radical production member is a chamber within the lip section of the cylinder liner, and wherein the cylinder liner is removably affixed to the at least one cylinder.

4. The method of claim 3, wherein the chamber has a volume of space ranging from one-twentieth to one-quarter the volume of the main combustion chamber when a piston is at top-dead center.

5. The method of claim 1, wherein the at least one radical production member is made of steel for use with a heavy fuel source.

6. The method of claim 1, wherein the at least one radical production member is made of an iron compound for use with an alcohol based fuel source.

7. The method of claim 1, further comprising:
replacing the at least one production member with at least one production member made of a different material to be used with a different fuel source.

8. A method of modifying internal combustion engine with at least one cylinder to control the production and flow of radical ignition species for enhanced combustion, comprising:
forming at least one annular channel in a top surface of an engine block around the circumference of at least one opening defining at least one cylinder in the engine block;
inserting a cylinder liner into the at least one cylinder of the internal combustion engine, the cylinder liner comprising at least one radical production member for providing and storing radical ignition species, wherein the at least one production member is disposed inside of the cylinder liner and has at least one opening to fluidly connect each of the at least one production member to each of the at least one lined cylinder; and
assembling an engine block, the at least one radical production member, and a cylinder head.

9. The method of claim 8, wherein the at least one annular channel is of a depth substantially equal to the thickness of a lip section of the cylinder liner so the at least one production member is substantially disposed within the annular channel.

10. The method of claim 8, wherein at least one production member further comprises a plurality of chambers in an outer circumferential surface of the lip section of the cylinder liner for storing a volume of radical ignition species, and wherein the plurality of chambers have a volume of space ranging from approximately one-twentieth to one-quarter the volume of the main combustion chamber when a piston is at top-dead-center to enable radical species ignition in the modified IC engine.

11. The method of claim 8, further comprising:
creating at least one annular channel in a bottom surface of a cylinder head so as to correspond in location to the at least one annular channel in the engine block,
wherein the at least one annular channel of the engine block are of a depth so only a portion of the thickness of the lip section of the cylinder liner is disposed within the at least one annular channel of the engine block, and
wherein the at least one annular channel of the cylinder head is of a sufficient depth so a remaining portion of the lip section of the cylinder liner is disposed within the at least one annular channel of the cylinder head.

12. A modified internal combustion engine, comprising:
a cylinder head;
an engine block containing a plurality of cylinders and a plurality of pistons;
a cylinder liner, wherein the cylinder liner includes a lip section and a body section,
wherein a plurality of main combustion chambers are defined by the lined cylinders, the pistons, and the cylinder head;
a plurality of production members, wherein the production members are disposed within the lip section of the cylinder liner and include at least one vent to fluidly connect the production members with the main combustion chambers; and
wherein the cylinder liner is partially disposed between the engine block and the cylinder head and attached to the engine block via a friction fit.

13. The modified internal combustion engine of claim 12, wherein the radical production members are chambers within the lip section of the cylinder liner, and wherein the cylinder liner is removably affixed to the at least one cylinder.

14. The modified internal combustion engine of claim 13, wherein the chambers have a volume of space ranging from approximately one-twentieth to one-quarter the volume of the main combustion chamber when the piston is at top-dead center.

15. The modified internal combustion engine of claim 12, wherein the radical production members are made of steel for use with a heavy fuel source.

16. The modified internal combustion engine of claim 12, wherein the radical production members are made of iron compounds for use with an alcohol based fuel source.

17. An apparatus, comprising:
a cylinder liner, wherein the cylinder liner includes a lip section and a body section, the body section shaped and sized to friction fit within a plurality of cylinders in an engine block; and
a plurality of production members, wherein the production members are disposed within the lip section of the cylinder liner and include at least one vent to fluidly connect the production members with a plurality of main combustion chambers defined by the plurality of lined cylinders.

18. A method of modifying an internal combustion engine with at least one cylinder to control the production and flow of radical ignition species for enhanced combustion, comprising:
adding, to a gasket, a plurality of reservoirs for providing and storing radical ignition species, wherein the gasket has at least one opening corresponding to the at least one cylinder in an engine block and the plurality of reservoirs are disposed inside of the gasket and have at least one vent to fluidly connect each of the plurality of reservoirs to at least one cylinder in the engine block; and
attaching the gasket and added plurality of reservoirs to the engine block, wherein the gasket is disposed between the engine block and a cylinder head of the internal combustion engine, such that the at least one opening corresponds to the at least one cylinder in an engine block, and each of the plurality of reservoirs fluidly connect to a corresponding main combustion chamber, wherein the at least one cylinder defines the corresponding main combustion chamber.

19. The method of claim 18, wherein the attaching further comprises:
disposing the gasket between the engine block and the cylinder head of the internal combustion engine, wherein an assembly of the engine block, the gasket, and the cylinder head is secured via a set of head bolts.

20. The method of claim 18, wherein the plurality of reservoirs have a volume of space ranging from one-twentieth to one-quarter the volume of the main combustion chamber when a piston is at top-dead center.

21. A modified internal combustion engine, comprising:
a cylinder head;
an engine block containing a plurality of cylinders and a plurality of pistons,
wherein a plurality of main combustion chambers are defined by the cylinders, the pistons, and the cylinder head;
a gasket, wherein the gasket includes a plurality of openings corresponding to the plurality of cylinders in the engine block;
a plurality of reservoirs, wherein the plurality of reservoirs are disposed within the gasket and include at least one vent to fluidly connect the reservoirs with the main combustion chambers; and
wherein the gasket is disposed between the engine block and the cylinder head and attached to the engine block via a plurality of head bolts.

22. The modified internal combustion engine of claim 21, wherein the plurality of reservoirs are either a circular void, a contoured void based on the preexisting shape of the gasket, or both.

23. The modified internal combustion engine of claim 21, wherein the plurality of reservoirs have a volume of space ranging from approximately one-twentieth to one-quarter the volume of the main combustion chamber when the piston is at top-dead center.

24. An apparatus, comprising:
a gasket, wherein the gasket includes a plurality of openings corresponding to a plurality of cylinders in an engine block; and
a plurality of reservoirs, wherein the plurality of reservoirs are disposed within the gasket and include at least one vent to fluidly connect the plurality of reservoir with a plurality of main combustion chambers defined by the cylinders.
